(19) United States
(12) Patent Application Publication
(10) Pub. No.: US 2005/0087723 A1
(43) Pub. Date: Apr. 28, 2005

(54) Covering material for liquid substances and beds and a method for producing the same

(75) Inventor: Werner Berg, Postdam (DE)

Correspondence Address: Norris McLaughlin & Marcus, 220 East 42nd Street, 30th Floor, New York, NY, 10017, US

(73) Assignee: Institut fuer Agrartechnik Bornim e.V., Postdam (DE)

(21) Appl. No.: 10/501,321

(22) PCT Filed: Jan. 14, 2003
(86) PCT No.: PCT/EP03/00301

(30) Foreign Application Priority Data
Jan. 14, 2002 (DE) 102 02 936.9

(51) Int. Cl. C09K 3/00

(52) U.S. Cl. 252/193

(57) ABSTRACT

The invention concerns a covering material for liquid substances and product heaps and a method for its production. The task assignment of the invention is to offer covering materials which effectively reduce the emissions, which do not have a disadvantageous effect on other emissions and which do not cause high expenditures. The solution of the task assignment is effected with a covering material for liquid substances and product heaps consisting of an inert carrier material that is combined with active additives.

The invention concerns a covering material for liquid substances and product heaps and a method for its production in accordance with the generic terms of claims 1 and 12.

The invention concerns, in particular, materials for covering liquid substances or product heaps for the purpose of reducing gaseous emissions. With the use of the materials, slurry tanks, slurry channels, clarification tanks and other open vessels of the agricultural sector as well as the pharmaceutical and foodstuffs industry can be covered off. The materials can also be applied for covering product heaps which occur, for example, with the storage of excrement in livestock breeding.

The emissions of odour, ammonia (NH₃), methane (CH₄) and dinitrogen monoxide (N₂O) from liquid substances such as slurry, waste water and similar items as well as from product heaps such as manure storage facilities and similar items are undesirable and can be at least partially reduced with various measures. These measures can be subdivided into the following categories:
Encapsulation of the emittents
Application of added substances and
Treatment processes

The most uncomplicated form of encapsulation is the covering of the emittents with materials suitable for this purpose, such as straw, granulates, bentonites, expanded clay or other fillings, turf or foils.

Such materials are described, for example, in DE 19714869 and DD 300453 and involve mixtures of pearlite, fly ash, calcium oxide, cement, hydrophobised silicic acid as well as polymers of organic binding agents and further constituents.

From DE 29622384 a floating covering layer consisting of synthetic material is known.

A vessel covering with a foil or sheet cover is shown in DE 19504740.

The use of added substances causes a reduction of the emissions by means of the change of the characteristics of the emittents. The reduction of the pH-value with the adding of acid is very effective. The use of organic acids, as described for example in DE 4139682 A1, is particularly environmentally compatible. In emittents containing acid-forming micro organisms, the acid formation and subsequently the pH-value-reduction can be forced by adding glucose, saccharose or an easily degradable organic substance, as described in DE 19714588.

Treatment processes such as solid-liquid-separation, stripping or their combination can also reduce the emissions to a great extent. However, they also involve very high costs.

The measures known up to the present for the reduction of the emissions as stated above have one, more or all of the following disadvantages:
They have a low effect
They are aimed at only individual emissions
They increase other emissions
They cause high costs.

For this reason the task assignment of the invention is to offer covering materials which effectively reduce the emissions and which do not have a disadvantageous effect on other emissions and which do not cause high expenditures.

The solution of the task assignment is effected with the features of the claims 1 and 10.

Advantageous embodiments are stated in the Sub-Claims.

In this way, the covering material according to the invention for liquid substances and product heaps consists of an inert carrier material that is combined with active additives.

In an advantageous embodiment of the invention, the inert carrier material consists of solid materials such as straw, granulates, bentonites, expanded clay and further possibly porous mineral materials with a density of less than 1 g/cm³, turf and foils. According to the invention and as active additives, pH-value-reducing substances or substance mixtures are put into the inert carrier material.

In an advantageous embodiment of the invention the active additives are, in particular, acids and salts which show an acidic reaction in water solution. In particular, inorganic and organic acids and their salts are applied as acids.

In a further advantageous embodiment, lactic acid and its salts (lactates) are put into the carrier material.

In a further advantageous embodiment of the invention, convertible substances are added to the inert carrier material by means of micro organisms or enzymes which form acid during the sequence of the microbiological conversions. According to the invention, substances containing carbohydrates are suitable for this purpose. In particular, organic residual substances containing sugar and carbohydrates can be advantageously and inexpensively added to the carrier materials.

In this way and in a further embodiment of the invention, glucose, saccharose or molasses are adopted.

The covering material according to the invention is produced by mixing the inert carrier material with the active additives.

In an advantageous embodiment of the production process, the active additives are fixed on the surface of the inert carrier material

In a further embodiment of the invention, the fixation of the additives can for example be achieved by means of a hydrophobic treatment.

In a further embodiment of the invention, it is an advantage to heat the inert carrier material with active additives before mixing and fixation.

A further advantageous embodiment of the invention envisages the application of stearates, silicane emulsions or other hydrophobising substances as hydrophobic agents.

A further advantageous embodiment of the invention envisages the subjection of the inert carrier material to a temperature treatment between 100 and 700° C. before the active additives are put in. An optimal fixation of the active additives is achieved in this way.

The invention causes a reduction of the pH-value of the emittent in the contact area with the covering material according to the invention. The reason why this happens is that the covering material with the active additives gradually discharges the active additives to the emittent, so that the pH-value of the emittent declines in particular at its surface—the location of the emissions. This combination of covering and pH-value-reduction of the emittent makes possible an effective emission reduction, especially by the fact that the reduction of the pH-value takes place at the emittent surface in particular and not in its entire volume at one and the same time.

This is a significantly decisive difference compared to the solutions as described in DE 19714869, DE 29622384, DE 19504740, DE 4139682 and DE 19714588.

The addition of acids (and acid-producing micro organisms as well as substances which form their nutrition basis) as described in DE 4139682, or the addition of glucose, saccharose or easily degradable organic substance as described in DE 19714588, produce a reduction of the pH-value of the emittent especially at the bottom of the storage vessel, whereas the pH-value-declining on the surface of the emittent is less. This is attributable to the fact that the density of the added substances is greater than the density of the emittents—the added substances sink downwards, and attributable to the fact that the micro organisms mainly produce acid in the lower sediment layer of the emittents, at the bottom of the storage vessels, because they find their nutrition basis at that location.

With the use of the covering material according to the invention the reaction is the exact opposite. Based on the fact that the covering material functions as a carrier for the pH-value-reducing added substances—these substances therefore being on the surface of the emittents—the pH-value of the emittents undergoes a greater reduction at their surface than in their lower layers (compare the examples as described). In this way, the microbiological activities and/or the discharge of NH₃ are hardly influenced in the predominant volume, particularly also near the bottom.

Also, and with reference to the effects, the new solution has substantial advantages compared with the known solutions. With the materials described in DE 19714869 or also with the expanded clay, good results are obtained with regard to the emission reduction of odour, ammonia and also methane. In a disadvantageous manner, their usage produces emissions of dinitrogen monoxide (N₂O) which do not occur otherwise. These emissions are judged very negatively because they contribute towards the anthropogenic heatup of the earth's atmosphere and to climatic changes, in actual fact with 310-times the specific green-house gas potential as carbon dioxide (CO₂).

For the covering materials according to the invention, all known materials and mixtures can be used with great advantage that could be used formerly for the reduction of emissions of liquid emittents.

These are for example straw, granulate, bentonite, expanded clay, further mineral materials, turf or foils. When using straw as a covering material, this should be hacked as required.

Organic or inorganic acids, acid mixtures, salts of the acids or also substances which cause an acid formation under the effect of micro organisms, can be added to the covering materials. Suitable are, for example, 2-hydroxy propane acid (lactic acid) and their salts (lactates).

The combination of the inert carrier material with active added substances is performed preferentially before the addition to the emittents.

For this purpose, the carrier material and the active added substances are put together into a vessel so that the carrier material can take up the added substances. Further substances can be added to the carrier material which delay the discharge of the added substances to the emittent, meaning, a fixation, at least a partial fixation of the active added substances is achieved. After one day for example, the covering material according to the invention can then be removed from the vessel. Before the covering material is given to the emittent and/or is mixed into it, it should be preferentially subjected to an additional treatment process. This treatment is to be carried out in such a way that a gradual discharge of the added substances to the emittent is possible (partial fixation) and, at the same time, the absorption of moisture through hydrophobising is extensively avoided. Stearates, silicane emulsions or other hydrophobic substances/agents can be used for this treatment. Here and as a rule, the heatup of the material acts positively on the effect of the hydrophobising.

Between the covering material and the emittent, membranes can also be located which are permeable for hydrogen-ions (H⁺) but not for the acid residual-ions. This boosts the effect of the covering material.

Preferentially the carrier material should be provided first with added substances and, after that, treated as described. But already hydrophobised granulates, bentonites or expanded clay can also be used.

Already hydrophobised material should at first be heated up to a temperature of 100 to 200° C. Following this, the carrier material and the added substances are placed together into a vessel, in which both are mixed. In doing so, ensure that at this time the temperature is below the boiling temperature of the added substance. The addition of further substances which delay the discharge of the added substances to the emittent is possible. The covering material according to the invention can be removed from the vessel after one day. Before the covering material is given to the emittent and/or is mixed into this, it should be preferentially subjected to an additional treatment. The treatment is to be carried out in such a way that a gradual discharge of the added substance to the emittent is possible (partial fixation).

The covering material should be deposited onto the emittent with a layer thickness of 8 cm.

If the emission-reducing effect of the covering material according to the invention diminishes, the added substance can be re-dosed where it is applied to the surface as uniformly as possible.

The invention is described in greater detail in the following examples and based on the chart.

### EXAMPLE 1

20 volume percent lactic acid is added to 100 volume percent pearlite. After one day the material is heated to 120° and hydrophobised with a silicane emulsion.

### EXAMPLE 2

20 volume percent lactic acid is added to 100 volume percent expanded clay. After one day the material is heated to 120° and hydrophobised with a silicane emulsion.

### EXAMPLE 3

20 volume percent lactic acid is added to 100 volume percent hacked straw. After one day the material is hydrophobised with a silicane emulsion.

At the beginning stage of the storage, a pig slurry was provided with a 6 cm thick covering layer from the material as described and, for comparison with this, stored without covering. After a storage duration of 10, 40 and 80 days the pH-values as stated in the chart were measured below the covering layer near the slurry surface and about 30 cm below the slurry surface at the bottom of the storage vessel.

CHART

| | | | | pH-value of | | |
|---|---|---|---|---|---|---|
| | pH-value of | | | slurry at bottom | | |
| | slurry below | | | of the storage | | |
| | covering measured | | | vessel, measured | | |
| | after | | | after | | |
| Slurry | 10 | 40 | 80 | 10 | 40 | 80 |
| covering | days | days | days | days | days | days |
| None | 6.6 | 7.2 | 7.6 | 6.5 | 7.1 | 7.5 |
| 6 cm pearlite | 5.7 | 5.4 | 5.4 | 6.0 | 5.8 | 5.6 |
| with 20 volume | | | | | | |
| percent lactic acid | | | | | | |
| 6 cm expanded clay | 4.8 | 6.1 | 6.0 | 5.3 | 6.2 | 6.0 |
| with 20 volume | | | | | | |
| percent lactic acid | | | | | | |

1. Covering material for liquid substances and product heaps consisting of inert carrier material that is combined with active and hydrophobising additives,
wherein
the inert carrier material contains pH-value-reducing substances or substance mixtures.

2. Covering material according to claim 1,
wherein
acids and salts are contained.

3. Covering material according to claim 1,
wherein
inorganic and organic acids and salts are contained.

4. Covering material according to claim 1,
wherein
lactic acid and its salts are contained.

5. Covering material according to claim 1,
wherein
convertible substances are contained through micro organisms or enzymes.

6. Covering material according to claim 1,
wherein
substances having carbohydrates are contained.

7. Covering material according to claim 1,
wherein
organic residual substances having sugar and/or carbohydrates are contained.

8. Covering material according to claim 1,
wherein
glucose, saccharose, molasses are contained.

9. Covering material according to claim 1,
wherein
the carrier materials containing the active substances are combined with foils which are predominantly permeable for hydrogen-ions only.

10. Method for the production of covering material according to claim 1,
wherein
the inert carrier material is mixed with active additives and, following this, is subjected to a hydrophobising treatment.

11. Method for the production of covering material according to claim 10,
wherein
the active additives are fixed on the surface of the inert carrier material.

12. Method for the production of covering material according to claim 10,
wherein
the inert carrier material is heated before mixing and/or fixation with active additives.

13. Method for the production of covering material according to claim 10,
wherein
the inert carrier material is heated to a temperature between 100 and 700° C. before the input of active additives.

14. Method for the production of covering material according to claim 10,
wherein
stearates, silicane emulsions or other hydrophobic substances are applied as hydrophobising agents.

15. Method for the production of covering material according to claim 10,
wherein,
between the covering material and emittent, a foil is placed which is predominantly permeable for hydrogen-ions only.
